(19) United States
(12) Patent Application Publication
(10) Pub. No.: US 2024/0246205 A1
(43) Pub. Date: Jul. 25, 2024

(54) Method for Operating a Hand-Held Power Tool

(71) Applicant: Robert Bosch GmbH, Stuttgart (DE)

(72) Inventors: Christoph Steurer, Urbach (DE); Jasmin Giessler, Steinach (DE); Marcus Schuller, Dettenhausen (DE); Stefan Mock, Remshalden (DE); Simon Erbele, Nufringen (DE); Wolfgang Herberger, Stuttgart (DE)

(21) Appl. No.: 18/412,560

(22) Filed: Jan. 14, 2024

(30) Foreign Application Priority Data
Jan. 24, 2023 (DE) 10 2023 200 526.3

(51) Int. Cl. B25B 23/147; B25B 21/02

(52) U.S. Cl. CPC B25B 23/1475; B25B 21/02

(57) ABSTRACT

A method for operating a hand-held power tool, preferably a rotary impact wrench, the hand-held power tool comprising a tool holder for receiving a tool such as a tool bit or a nut, wherein the tool is configured to rotatably drive the fastener via a corresponding drive of a fastener includes partially releasing the fastener from a screwed state, by rotating the tool holder and thus the fastener in a first direction of rotation, rotating the tool holder in a second direction or rotation opposite the first direction of rotation, and renewed rotating of the tool holder and thus the fastener in the first direction of rotation.

This application claims priority under 35 U.S.C. § 119 to application no. DE 10 2023 200 526.3, filed on Jan. 24, 2023 in Germany, the disclosure of which is incorporated herein by reference in its entirety.

The disclosure relates to a method for operating a hand-held power tool, preferably a rotary impact wrench, a computer program for performing the method and a hand-held power tool configured to perform the method.

### BACKGROUND

Known from the prior art (see, e.g., EP 3 381 615 A1) are hand-held power tools for tightening and loosening screw elements, e.g. threaded nuts and screws, that are designed as rotary impact wrenches. Rotary impact wrenches comprise a structure in which an impact force in a rotational direction is transferred to a screw element by a rotary impact force of a hammer. A rotary impact wrench with this design, comprises a motor, a hammer intended to be driven by the motor, an anvil that is struck by the hammer, and a tool. Regarding the rotary impact wrench, the motor installed in a housing is driven, whereby the hammer is driven by the motor, the anvil is struck by the rotating hammer in turn, and a percussive force is delivered to the tool, whereby two different operating states, i.e., “no percussive operation” and “percussive operation,” can be distinguished.

Rotary impact wrenches are typically used with interchangeable nuts for hex heads or tool bits. A problem can arise if the nut or the bit gets jammed on or in the drive of the fastener or on the interface of the device for holding the accessories, such as nuts or bits, when releasing a fastener. In the scope of the present disclosure, the term “jam” or also “jamming” is used in this context. In some cases, the jammed component cannot be released, even with considerable force. This problem is quite common due to the high torques usually needed to loosen a screw connection and the pulse-like load from the impact operation.

Although the disclosure is described in the present disclosure primarily on the basis of a rotary impact wrench, it is not limited to this application, but can also be applied to other hand-held power tools comprising a rotary drive, e.g. cordless screwdrivers.

### SUMMARY

The object of the disclosure is to provide an improved method for operating a hand-held power tool compared to the prior art, which at least partly overcomes the aforementioned disadvantages, or at least is an alternative to the prior art. A further object is to specify a corresponding hand-held power tool.

Said objects are achieved by means of the respective subject matter of the disclosure. Advantageous embodiments of the disclosure are the subject matter of the disclosure.

Disclosed according to the disclosure is a method for operating a hand-held power tool, the hand-held power tool comprising a tool holder for receiving a tool, e.g. a tool bit or a nut. The tool is configured to rotatably drive the fastener via a corresponding drive of a fastener element. This method comprises the following steps:
S1 partially releasing the fastener from a screwed state by rotating the tool holder, and thus the fastener, in a first direction of rotation;
S2 rotating the tool holder in a second direction or rotation opposite the first direction of rotation;
S3 renewed rotation of the tool holder, and thus the fastener, in the first direction of rotation.

The rotation in the first direction of rotation as defined in step S1 in the context of the present description is to be understood as a rotation in the direction that causes the fastener to be released. For fasteners with a right-hand thread, this means a counterclockwise rotation. For fasteners with a left-hand thread, this means a clockwise rotation.

Rotating the tool holder in the second direction of rotation opposite the first direction of rotation causes the fastener to slightly rotate again into the screw support, which is accompanied by a friction torque between the fastener and the substrate in which the fastener is screwed. This friction torque enables potential jamming to be released. Depending on the embodiment of these steps, rotating the tool holder in the second direction of rotation opposite the first direction of rotation also results in partially re-tightening of the fastener. However, since a lower torque is required when loosening the slightly tightened screw than when initially rotating the tool holder in the first direction of rotation, jamming does not usually occur here again.

In this way, when releasing a fastening element with a rotary impact wrench, jamming of the drive and the fastening element or the drive and interface of the device can be reliably released.

So, a user does not need to remove the screw or nut from the nut or bit themselves, with or without additional tools such as pliers, or loosen the nut or bit from the device. Accordingly, the risk of injury is reduced when jamming is manually released.

Furthermore, the speed of releasing serial screwing operations is increased and the process is simplified by eliminating the need for an additional tool.

The partial release in step S1 can be performed at least partially using a rotary impact operation.

In some embodiments, the rotary impact operation in step S1 is replaced by a screwing operation without impact when the fastener falls below a predefined resistance to further release. Step S2 is performed as soon as the screwing operation without impact is detected.

This is advantageous in that an initial jamming of the drive and fastening element or the drive and the interface of the device is particularly likely during the rotary impact operation, and the release of any potential jamming directly after the rotary impact operation is therefore particularly effective.

In some embodiments, in step S2, if a certain torque is exceeded, a rotary impact operation is performed, and step S3 is performed once the rotary impact operation is detected. This embodiment is based on the idea that any potential jamming that may have occurred in step S1 is released particularly reliably due to the rotary impact that has just started and the associated few pulse-like loads on the interfaces between the fastening element, tool and tool holder. The level of the load on the tool holder and the fastener is significantly lower than when the screw connection is initially loosened, so that jamming does not occur again in step S2.

In certain embodiments, a rotary impact operation is performed in step S2 when a certain torque is exceeded, whereby step S3 is performed after a predefined time period after an automatic detection of the rotary impact operation, after a predefined number of impacts of the rotary impact operation, after detecting a certain number of Hal transitions after automatically detecting the rotary impact operation, after performing a predefined number of rotations of the tool holder after an automatic detection of the rotary impact operation, and/or after a predefined time period after an automatic detection of the rotary impact operation. The level of the pulse-like load acting on the potential jamming is therefore adjustable.

In some embodiments, step S3 is ended when a predefined time period has elapsed since the start of step S3 and/or since the start of step S1, or when a user releases an actuating switch of the rotary impact driver.

In some embodiments, the rotation is performed in the second or first direction of rotation in steps S2 and/or S3 while passing through a run-up ramp. A rotational speed of the tool holder is increased from a very small value to the desired rotational speed, e.g. continuously over a predefined time period or with a predefined slope. This is advantageous because sudden changes in the acceleration state of the tool holder, which in turn can be associated with jamming, are avoided.

In some embodiments, after actuation of an actuating switch of the hand-held power tool by a user, a controller of the hand-held power tool automatically detects that a fastener is being released and carries out the method according to steps S1 to S3. The automatic detection is in this case based on, e.g., observations at which points in time a rotary impact operation or a screwing operation without impact occurs during operation of the hand-held power tool, which is described in further detail hereinafter.

In some embodiments, the controller detects the release of the fastener at least partially based on an immediate onset of a rotary impact operation after actuation of the actuating switch.

In some embodiments, the controller detects the release of the fastener at least partially based on an immediate onset of a rotary impact operation after actuation of the actuating switch, provided that this rotary impact operation is followed by a screwing operation without impact.

Advantageously, detecting the rotary impact operation and/or screwing operation without impact is performed at least partially on the basis of a signal waveform of an operating variable of an electric motor of the hand-held power tool.

The method can therefore be performed completely automatically, with the resulting advantages in terms of the simplest possible handling of the hand-held power tool by a user.

In some embodiments, the method according to steps S1 to S3 is initiated by a user of the hand-held power tool actuating a control button separate from the actuating switch of the hand-held power tool, and a release of the actuating switch cancels and/or ends the method.

In this case, the user is free to independently react to any jamming which may possibly also be detected by the user.

In some embodiments, the method is started or initialized via a software application (app), in which case the app is executed on a terminal device separate from the hand-held power tool.

In addition to ease of operation by the user, this has, among other things, advantages with respect to an efficient adjustment of the parameters of the screwing operation and thus with respect to an efficient operation of the hand-held power tool.

In some embodiments, parameters of the screwing operation are adjustable via the app, in which case the parameters comprise one or a plurality of the following parameters:
diameter and/or type of fastener;
material, strength, and/or hardness of the substrate;
predefined time duration and/or number of impacts of a rotary impact operation in steps S1, S2, and/or S3.

In some embodiments, the rotation of the tool holder in the second direction of rotation opposite the first direction of rotation is performed in step S2 such that jamming of the tool in the tool holder and/or the drive of the fastener with the tool is released, but without the screw connection being tightened such that a renewed loosening of the screw connection in step S3 would result in renewed jamming.

Advantageously, in this case, a relatively high friction torque is applied between the fastener and the substrate, so that potential jamming can be released with a high degree of probability.

A further object of the disclosure is a computer program for performing the method described hereinabove when the computer program is executed by a controller of the hand-held power tool.

A further object of the disclosure is a hand-held power tool comprising an electric motor, a tool holder rotationally driven by the electric motor for receiving a tool, and a controller for controlling the electric motor. The controller is in this case configured to perform the method described hereinabove.

In the context of the present disclosure, the term “ascertaining” is meant to include in particular measuring or receiving, whereby “receiving” is understood in the sense of measuring and storing, and “ascertaining” also includes possible signal processing of a measured signal.

Furthermore, the term “deciding” is understood to mean recognizing or detecting, whereby a clear allocation is to be achieved. The term “identifying” means a detection of a partial match with a pattern, which can, e.g., be enabled by fitting of a signal to the pattern, a Fourier analysis, or the like. The term “partial match” is understood to mean that the fitting has an error that is less than a specified threshold value, in particular less than 30%, quite in particular less than 20%.

The signal of the operating variable is in this context understood to mean a temporal sequence of measured values. Alternatively, and/or additionally, the signal of the operating variable can also be a frequency spectrum. Alternatively, and/or additionally, the signal of the operating variable can also be reworked, for example smoothed, filtered, fitted, and the like.

Further features, possible applications, and advantages of the disclosure emerge from the following description of the exemplary embodiment of the disclosure, which is shown in the drawing. It should be noted that the features described or depicted in the drawings themselves or in any combination thereof describe the subject matter of the disclosure irrespective of their summary in the disclosure or their reverse relationship, as well as irrespective of their formulation or illustration in the specification or drawing and have only a descriptive character and are not intended to restrict the disclosure in any way.

### BRIEF DESCRIPTION OF THE DRAWINGS

The disclosure will be explained in further detail hereinafter with reference to the drawings. Shown are:

FIG. 1 a schematic illustration of a hand-held power tool;

FIG. 2 a flow chart of a method according to the disclosure;

FIG. 3 a schematic representation of a signal of an operating variable of a hand-held power tool; and

FIG. 4 a schematic illustration of two different records of the signal of the operating variable.

### DETAILED DESCRIPTION

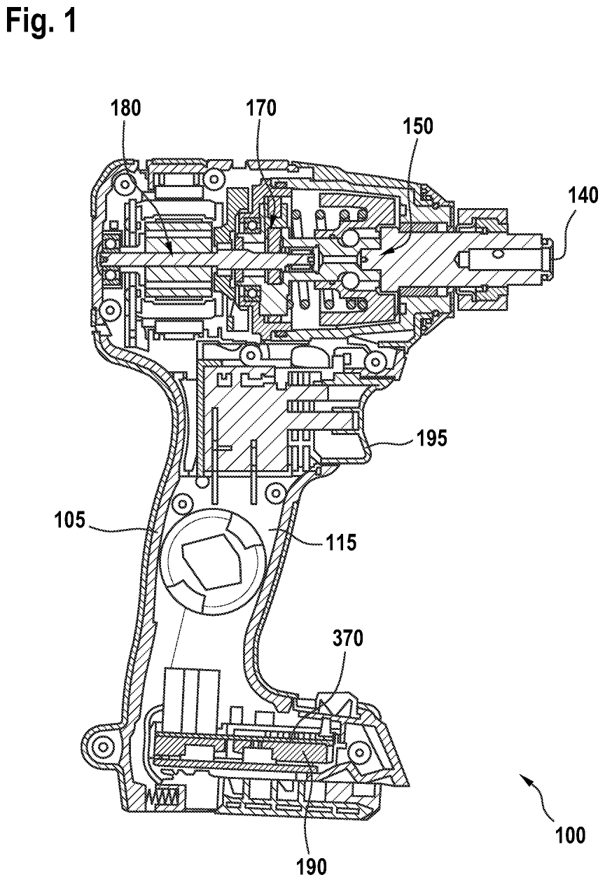

FIG. 1 shows a hand-held power tool 100 having a housing 105 with a handle 115. According to the embodiment shown, the hand-held power tool 100 is mechanically and electrically connectable to a battery pack 190 for off-grid power supply.

A powered electric motor 180 and a transmission 170 from the battery pack 190 are arranged within the housing 105. The electric motor 180 is connected to an input spindle via the transmission 170. Furthermore, a control unit 370 is arranged within the housing 105 in the region of the battery pack 190, which influences the electric motor 180 and the transmission 170 by means of, for example, a set motor speed n, a selected rotational pulse, a desired transmission gear x, or the like.

For example, the electric motor 180 is actuatable, i.e., switchable, via a hand switch or actuating switch 195, and can be any type of motor, for example, an electronically commutated motor or a DC motor. Generally, the electric motor 180 is electronically controllable or adjustable such that both a reversing operation and specifications regarding the desired motor speed n and the desired rotational pulse can be implemented. The functionality and construction of a suitable electric motor are sufficiently known from the prior art, so that a detailed description is omitted herein for the sake of brevity in the description.

A tool holder 140 is rotatably supported in the housing 105 via an input spindle and an output spindle. The tool holder 140 serves to receive a tool and can be directly formed on the output spindle and connected thereto in a cap-like manner.

The control unit 370 is in communication with a power source and is designed to electronically controllably or adjustably drive the electric motor 180 using various current signals. The various current signals provide for different rotational pulses of the electric motor 180, whereby the current signals are directed to the electric motor 180 via a control line. The power source can, e.g., be designed as a battery or, as in the illustrated exemplary embodiment, as a battery pack 190, or as a grid connection.

Furthermore, controls (not shown in detail) can be provided in order to adjust various modes of operation and/or the direction of rotation of the electric motor 180.

A solution to the problem described hereinabove will be described hereinafter, i.e., that when fastening elements are released with interchangeable nuts for hex heads or with tool bits, the nut or bit can become jammed on or in the drive of the fastening element, or the nut or bit can become jammed on the interface of the hand-held power tool 100 for holding the accessory. This issue is quite common due to the high torques needed to loosen a screw connection and the pulse-like load from the impact operation in the case that the hand-held power tool 100 is a rotary impact wrench.

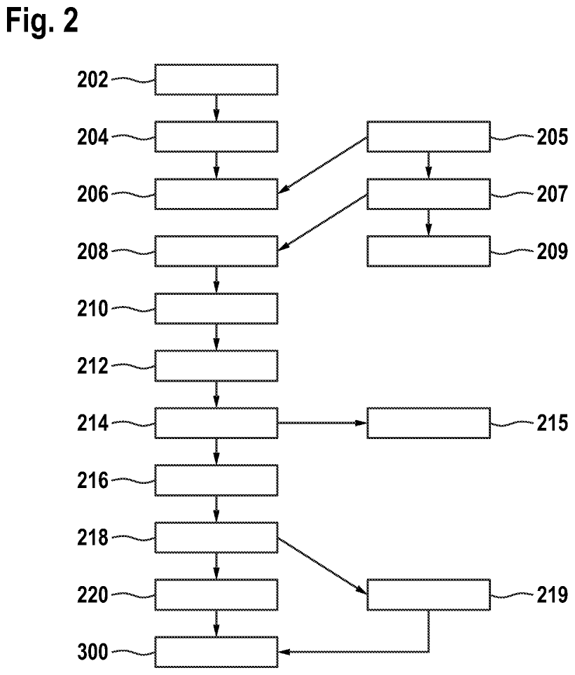

FIG. 2 shows a flowchart of an exemplary embodiment of the method according to the disclosure. In step 202, a user of the hand-held power tool 100 actuates the actuating switch 195 to release a fastener from a screwed state. The tool holder, and thus the fastener, rotates in a first direction of rotation. In the case of conventional fasteners with a right-hand thread, the first direction of rotation is counterclockwise, whereby the reference point is taken as the perspective of the user looking at the fastener to be screwed. For fasteners with a left-hand thread, the first direction of rotation is clockwise.

Partially releasing the fastener by rotating the tool holder and thus the fastener in the first direction of rotation is referred to as step S1 in the context of the present disclosure.

In embodiments of the disclosure, partially releasing the fastener in step S1 is performed at least partially using a rotary impact operation dependent on the level of the torque applied. In embodiments of the disclosure, the controller at 205 automatically implies that the fastener is, e.g., being released at least partially based on a detection an immediate onset of a rotary impact operation after actuation of the actuating switch 195 in 204.

The technical background in this regard is that an immediate onset of the rotary impact operation for a screw connection (i.e., tightening) of a fastener is rather unusual, because in this case the screw resistance only slowly builds up with progressive tightening of the fastener. On the other hand, if the fastener has been screwed with a certain torque and now is to be released, the torque required to rotate the fastener when starting the screwing operation is already so great that the rotary impact operation is immediately triggered in-device. In this case, in 205, the controller implies that a fastener should be released. The method according to the disclosure can then be started automatically.

Alternatively, in embodiments, it can be provided that the controller detects that a fastener is being released using other parameters, e.g. based on the direction of rotation of the tool holder. In this context, however, it must be noted that fasteners with left-hand and right-hand threads are common and that further sensors can be required to determine the direction of rotation of the tool holder.

With respect to the embodiment shown in FIG. 2, it should be noted that the controller in 205 initially only implies or indicates that a screw connection is being loosened if in 204 an immediate onset of a rotary impact operation is detected after actuation of the actuating switch 195. Specifically, it is possible that a user does not perform a release process, but wants to further tighten or check a fastener that has already been screwed in to a certain degree. In this case, the applied torque would also be so great that it would trigger an immediate onset of the rotary impact operation.

It will be explained in more detail hereinafter how the controller detects the onset of the rotary impact operation. In summary, it can be said that detecting the rotary impact operation and/or screwing operation without impact is performed at least partially on the basis of a signal waveform of an operating variable of the electric motor 180 of the hand-held power tool 100.

In this case, a comparison of a curve of the signal waveform of the operating variable of the electric motor 180 with a model signal waveform can be made.

In some embodiments, a user of the hand-held power tool 100 actuates a control button separate from the actuating switch 195 of the hand-held power tool 100 in order to perform the method according to the disclosure, whereby, a release of the actuating switch 195 cancels and/or ends the method.

Alternatively or additionally, it can be provided that the method is started or initialized via a software application (app), whereby the app is executed on a terminal device, for example, on a smartphone or a tablet, separate from the impact wrench 100. This can be particularly advantageous in embodiments in which a parameterization of the screwing operation can, e.g., also be performed with regard to one or more of the following parameters: diameter and/or type of fastener, material, strength, and/or hardness of the substrate; and predefined time period and/or number of impacts of a rotary impact operation.

The torque required to rotate the fastener decreases as the screw connection is continuously loosened. As a result, the rotary impact operation in step S1 is replaced by a screwing operation without impact when the fastener falls below a predefined resistance to further release. The screwing operation without impact is detected by the controller in the method step characterized in FIG. 2 as step 206. The succession of the immediate onset of the rotary impact operation at 204 and the screwing operation without impact at 206 is interpreted by the controller at 207 as confirmation of the implication made at 205, that a screw connection is being loosened, as it would be unusual for the torque to decrease again and a screwing operation without impact to start when retightening an already tightened fastener or when checking a tightened fastener, in which case the immediate onset of the rotary impact mode would also be detected at 204. The logic described in connection with steps 205 and 207 thus enables the controller 370 of the rotary impact wrench 100 to automatically detect that a fastener is being released.

After confirming the work case “release” in 207, in 208 the electric motor 180 is immediately stopped. At this point, the tool could be jammed in the tool holder and/or the drive of the fastener with the tool, which could have, e.g., occurred in step S1. This is particularly likely if, in step S1, as is the case in the embodiment described in FIG. 2, a rotary impact operation is performed, which is associated with high pulse-like loads on the interfaces between the tool, tool holder, and drive of the fastener. The jamming may have been completely unnoticed by the user in step S1.

To release potential jamming, the tool holder is now rotated at 210 in a second direction of rotation opposite the first direction of rotation, which is referred to as step S2 in the context of the present disclosure. By rotating in the opposite direction of rotation to the first direction of rotation, the fastening element is slightly re-tightened, thereby building up a friction torque between the fastening element and the screw base. This friction torque is transmitted in the interfaces between the drive of the fastener, tool, and tool holder, and acts in the opposite direction to the torque that caused or facilitated jamming. Jamming can thereby be released in step S2.

The rotation in the second direction of rotation is performed using predefined parameters, for example with respect to rotational speed or torque, which in embodiments of the disclosure may be different from the parameters selected by the user at the start of releasing the fastener in step S1.

In the embodiment shown in FIG. 2, if a certain torque is exceeded during rotation of the tool holder in the second direction of rotation, a rotary impact operation is performed in step S2, which is detected at 212 and means that the fastener is now re-tightened at a relatively high torque.

Since it is only intended to release potential jamming, which is most likely achieved at the latest with the onset of the rotary impact operation when rotating in the second direction of rotation, and not re-tightening of the connecting means, the controller stops the electric motor as a result of detecting the rotary impact operation at 214, and at 216 rotates the tool holder and thus the fastener again in the first direction of rotation, which is referred to as step S3 in the context of the present disclosure.

Alternatively, step S3 can be performed after a predefined time period after detecting the rotary impact operation and/or after a predefined number of impacts of the rotary impact operation. This ensures that the torque counteracting jamming is increased slightly at the affected interfaces. Further alternative embodiments include that step S3 is performed after determining a certain number of Hal transitions after automatically detecting the rotary impact operation, after performing a predefined number of rotations of the tool holder after automatically detecting the rotary impact operation, and/or after a predefined time period after automatically detecting the rotary impact operation.

For the renewed rotation in the first direction of rotation, the screw parameters originally selected for releasing the fastener are initialized again at 215 in the embodiment of FIG. 2.

In embodiments of the disclosure, during the transition from the first to the second direction of rotation, or from the second to the first direction of rotation between steps S1 and S2, or S2 and S3, a run-up ramp is passed through in order to keep loads on the fastener, the rotary impact wrench and the user low, and to prevent the tool from slipping off the fastener. It can also be provided that the stoppage of the electric motor 180 described at 208 and 214 is more or less pronounced, up to the case where virtually smooth transitions between the direction of rotations are implemented and a stoppage is therefore not present.

It is provided in embodiments of the disclosure that step S3 is ended when a predefined time period has elapsed since the start of step S3 and/or since the start of step S1, or when a user releases an actuating switch of the rotary impact driver.

In the embodiment shown in FIG. 2, renewed rotation in the first direction of rotation at 216 still occurs for a short time while performing a rotary impact operation as a result of the fastener being partially tightened at 212 in the second direction of rotation. The rotary impact operation in the first direction of rotation is detected by the controller at 218, which triggers a screwing mode set for this case at 219. This screwing mode can, e.g., involve unscrewing the fastener at increased speed or slowly reducing the rotational speed.

In 300, the controller stops the electric motor 180.

Alternatively, the method can be ended by the user releasing the actuation switch 195 at 220, which in turn results in stopping the electric motor 180 at 300.

As already further described hereinabove, the rotation of the tool holder in the second direction of rotation opposite the first direction of rotation is performed in step S2 such that jamming of the tool in the tool holder and/or the drive of the fastener with the tool is released, but without the screw connection being tightened such that a renewed loosening of the screw connection in step S3 would result in renewed jamming.

The following describes a method, by means of which the controller can determine whether there is a rotary impact operation or a screwing operation without impact. Alternative options for such detection are also applicable in the method according to the disclosure.

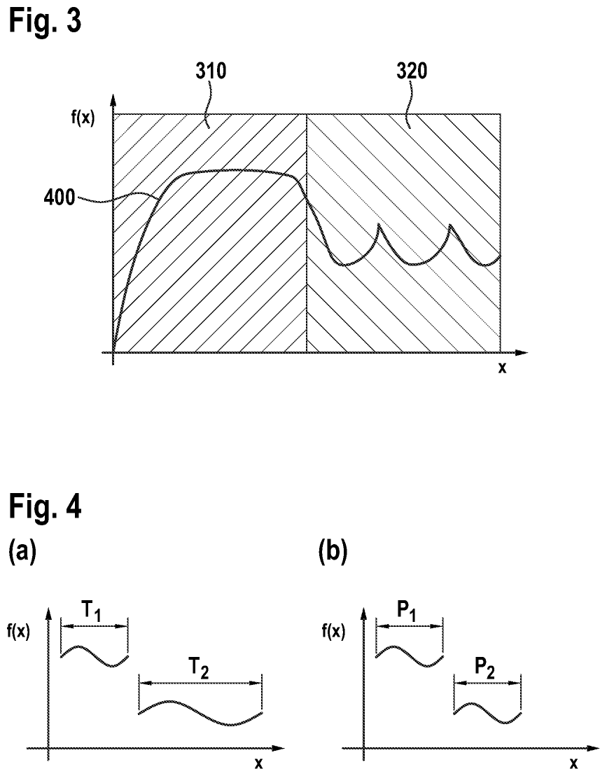

FIG. 3 shows a signal 400 of an operating variable of the electric motor 180 of the hand-held power tool 100, as it occurs in the same or a similar form when using the hand-held power tool 100 as intended.

Time is plotted on the ordinate x in the present example of FIG. 3, but in alternative embodiments an alternative variable, for example the motor rotational angle, is also selected as the reference value. On the abscissa f(x) in the drawing, the motor speed n present at each time point is plotted. Instead of the motor speed, another operating variable correlating to the motor speed can also be selected. In alternative embodiments of the disclosure, f(x) represents, e.g., a signal of motor current.

The motor speed and the motor current are operating variables that are typically detected by the controller 370 on hand-held power tools 100, without any additional effort. Recording the signal of an operating variable of the electric motor 180 is further referred to as step A2. In preferred embodiments of the disclosure, a user of the hand-held power tool 100 can select on the basis of which operating variable the disclosed method is intended to be performed.

It can be seen in FIG. 3 that the signal comprises a first region 310 characterized by a monotonous increase in motor speed, as well as a region of comparatively constant motor speed, which can also be referred to as a plateau. The intersection point between ordinate x and abscissa f(x) in FIG. 3 corresponds to the start of hand-held power tool 100 during the screwing operation.

In the first area 310, the hand-held power tool 100 operates in the operating state of the screw without impact.

In a second area 320, the hand-held power tool 100 operates in rotary impact operation. The rotary impact operation is characterized by an oscillating course of the operating signal, whereby the shape of the oscillation can be trigonometric, e.g. sinusoidal, or otherwise oscillating. In the present case, the oscillation has a course which can be referred to as a modified trigonometric function, whereby the upper half-wave of the oscillation has a pointed hat or tooth-like shape. This characteristic shape of the operating signal in rotary impact operation results from the drawing up and free-running of the impact mechanism striker and the system chain located between the impact mechanism and the electric motor 180, among others, of the transmission 170.

The qualitative signal waveform of the impact operation is thus generally known due to the inherent characteristics of the hand-held power tool. In embodiments of the method according to the disclosure, at least one state-typical model signal waveform is established in a step A1 on the basis of this knowledge, whereby the state-typical model signal waveform is associated with a first operating state, in the example of FIG. 3 thus the rotary impact operation in the second region 320. In other words, the state-typical model signal waveform contains typical characteristics for the first operating state such as the presence of a vibration curve, vibration frequencies or amplitudes, or individual signal sequences in continuous, quasi-continuous, or discrete form.

In other applications, the first operating state to be detected can be characterized by other signal waveforms than vibrations, such as by discontinuities or growth rates in the function f(x). In such cases, the state-typical model signal waveform is characterized by precisely these parameters, rather than vibrations.

In embodiments of the disclosure, the operating state to be detected is the rotary impact operation. According to the method, it can be provided that in the absence of detection of the operating state to be detected, it is concluded that there is a specific other operating state, for example, screwing without impact. Two or more first operating states can also be defined, the occurrence of which is monitored, for example, the rotary impact operation and the screwing operation without impact.

In a preferred embodiment of the disclosed method, in step A1 the state-typical model signal waveform can be established by the user, e.g. by selecting different pre-set signal waveforms or signal characteristics. In other embodiments, the state-typical model signal waveform is permanently stored by the manufacturer of the hand-held power tool 100 before it is delivered and is thereby established.

In step A3 of the method according to the disclosure, the signal of the operating variable of the electric motor 180 is compared to the state-typical model signal waveform. The “comparison” feature is intended to be interpreted broadly and in the sense of a signal analysis in the context of the present disclosure, so a result of the comparison can in particular also be a partial or gradual match of the signal of the operating variable 400 of the electric motor 180 to the state-typical model signal waveform, whereby the degree of matching of the two signals can be ascertained by various methods, which will be specified hereinafter.

In step A4 of the method according to the disclosure, the decision as to whether the first operating state is present is made at least in part on the basis of the result of the comparison. In this case, the degree of matching is a parameter that can be set by the factory or user for adjusting a sensitivity of detection of the first operating state.

In practical applications, it can be provided that steps A2, A3, and A4 are performed repeatedly during operation of the hand-held power tool 100 in order to monitor operation for the presence of the first operating state. For this purpose, in step A2, the recorded signal of the operating variable 400 can be sequenced, so that the steps A3 and A4 are performed on signal sequences, preferably always of the same established length.

For this purpose, the signal of the operating variable can be stored in a memory, preferably a ring memory, of a rotary impact wrench 100 as a result of measured values.

As previously mentioned in connection with FIG. 3, in preferred embodiments of the disclosure, in step A2, the signal of the operating variable is recorded as a time course of measured values of the operating variable, or as measured values of the operating variable over a rotational angle of the electric motor 180. The measured values can be discrete, quasi-continuous, or continuous.

One particularly preferable embodiment provides for the signal of the operating variable to be recorded in step A2 as a time curve of measured values of the operating variable, and, in step A2a, for the time curve of the measured values of the operating variable to be transformed into a curve of the measured values of the operating variable over a rotational angle of the electric motor.

The advantages of this embodiment will be described hereinafter with reference to FIG. 4. Similar to FIG. 3, FIG. 4a shows signals f(x) of an operating variable over an ordinate x, in this case over the time t. As in FIG. 3, the operating variable can be a motor speed or a parameter correlating to the motor speed.

The drawing contains two signal profiles of the operating variable in the first operating mode, i.e., in rotary impact operation in the case of a rotary impact wrench. In both cases, the signal comprises a wavelength of an idealized vibration curve assumed to be sinusoidal, whereby the shorter wavelength signal, T1, has a curve with higher impact frequency and the longer wavelength signal, T2, has a curve with a lower impact frequency.

Both signals can be generated using the same hand-held power tool 100 at different motor speeds, and are dependent on, among other things, which revolution speed the user requests from the hand-held power tool 100 via the operating switch.

If, for example, the parameter “wavelength” is now to be used in order to define the state-typical model signal, at least two different wavelengths T1 and T2 would have to be stored as possible parts of the state-typical model signal for the present case, so that the comparison of the signal of the operating variable 400 with the state-typical model signal waveform in both cases leads to the result of “match”. Given that the motor speed can change generally and to a large extent over time, this also causes the wavelength sought to vary, thereby requiring the methods for detecting this impact frequency to be adjusted in an adaptive manner accordingly.

With a plurality of possible wavelengths, the effort of the method and programming would increase accordingly.

Therefore, the chronological values of the ordinates are in the preferred embodiment transformed into rotational angle values of the electric motor 180. This is possible because the rigid gear ratio of the electric motor to the impact mechanism results in a direct, known dependence of motor speed on the impact frequency. This normalization achieves a vibration signal of consistent periodicity independent of the motor speed, which is shown in FIG. 4b by the two signals belonging to T1 and T2, whereby both signals now have the same wavelength P1=P2.

Accordingly, in this embodiment of the disclosure, the state-typical model signal valid for all speeds can be established by a single parameter of the wavelength via the motor rotational angle.

In a preferred embodiment, the comparison of the signal of the operating variable 400 with the state-typical model signal 440 is performed using one of the comparison methods comprising band pass filtering, frequency analysis, parameter estimation, and/or cross-correlation, which is described in more detail hereinafter.

In embodiments with band pass filtering, the input signal, optionally transformed to rotation angle dependence as described, is filtered via a band pass whose passband matches a frequency established in connection with the state-typical model signal 440. In the event that amplitudes of this frequency exceed a previously established limit value, as is the case in the first operating state, the comparison in step A3 then results in the outcome that the signal of the operating variable is the same as the state-typical model signal waveform and that the first operating state is performed. Establishing an amplitude limit value can be considered in this embodiment as step A3a of a quality determination of the match of the state-typical model signal waveform with the signal of the operating variable, on the basis of which it is decided whether the first operating state is present or not in step S4.

In embodiments which use frequency analysis as the comparison method, the signal of the operating variable is transformed from a time range into the frequency range with corresponding weighting of the frequencies based on the frequency analysis, e.g. a Fast Fourier Transformation (FFT), whereby at this point the term “time range” is to be understood both as “course of operation variable over time” and a “course of the operating variable over the motor rotational angle” in accordance with the explanations hereinabove.

Methods other than the method for automatically detecting a rotary impact operation described above with reference to FIGS. 3 and 4, can be applied in the context of the disclosure to automatically detect in steps S1, S2, and/or S3 whether there is a rotary impact operation or a screwing operation without impact, and whether jamming has occurred. For example, sensors, e.g. accelerometers, can be provided for this purpose.

The disclosure is not limited to the exemplary embodiment described and illustrated. Rather, the disclosure also comprises all embodiments by a skilled person within the scope of the disclosure.

In addition to the described and illustrated embodiments, further embodiments are conceivable, which can comprise further modifications as well as combinations of features.

What is claimed is:

1. A method for operating a hand-held rotary impact wrench, the hand-held power tool comprising a tool holder configured to receive a tool such as a tool bit or a nut, wherein the tool is configured to rotatably drive the fastener via a corresponding drive of a fastener, the method comprising:
partially releasing the fastener from a bolted state by rotating the tool holder, and thus the fastener, in a first direction of rotation;
rotating the tool holder in a second direction of rotation opposite the first direction of rotation; and
renewed rotating of the tool holder, and thus the fastener, in the first direction of rotation following the rotating the tool holder in the second direction.

2. The method according to claim 1, wherein the partial releasing is accomplished at least partially by performing a rotary impact operation.

3. The method according to claim 2, wherein:
the rotary impact operation in the partial releasing is replaced by a screwing operation without impact when the fastener falls below a predefined resistance so as to prevent further loosening, and
the rotating the tool holder in the second direction is performed as soon as the screwing operation without impact is detected.

4. The method according to claim 2, wherein:
while rotating the tool holder in the second direction, a rotary impact operation is performed in response to exceeding a certain torque is exceeded; and
the renewed rotating of the tool holder in the first direction is performed once the rotary impact operation is detected.

5. The method according to claim 2, wherein:
a rotary impact operation is performed in rotating the tool holder in the second direction in response to exceeding a certain torque;
the renewed rotating of the tool holder in the first direction is performed after one ore more of a predefined time period after an automatic detection of the rotary impact operation, a predefined number of impacts of the rotary impact operation, detecting a certain number of Hal transitions after automatically detecting the rotary impact operation, performing a predefined number of rotations of the tool holder after an automatic detection of the rotary impact operation, and a predefined time period after an automatic detection of the rotary impact operation.

6. The method according to claim 1, wherein:
the renewed rotating of the tool holder in the first direction is ended when a predefined time period has elapsed since the start of the renewed rotating of the tool holder in the first direction and/or since the start of partially releasing the fastener; or
the renewed rotating of the tool holder in the first direction is ended when a user releases an actuating switch of the rotary impact driver.

7. The method according to claim 1, wherein the rotation is performed in the rotating the tool holder in the second direction, or in the renewed rotating of the tool holder in the first direction, while passing through a run-up ramp.

8. The method according to claim 1, wherein:
an actuating switch of the hand-held power tool is actuated by a user; and
a controller of the hand-held power tool automatically detects that a fastener is being released in response to the actuating and performs the partially releasing of the fastener, the rotating of the tool holder in a second direction, and the renewed rotating of the tool holder in the first direction.

9. The method according to claim 8, wherein the controller detects the release of the fastener at least partially based on an immediate onset of a rotary impact operation after actuation of the actuating switch.

10. The method according to claim 3, wherein detecting the rotary impact operation and/or screwing operation without impact is performed at least partially on the basis of a signal waveform of an operating variable of an electric motor of the hand-held power tool.

11. The method according to claim 1, wherein:
the method is initiated by a user of the hand-held power tool actuating a control button separate from the actuating switch of the hand-held power tool; and
a release of the actuating switch cancels and/or ends the method.

12. The method according to claim 1, wherein:
the method is started or initialized via a software application (app); and
the app is executed on a device separate from the hand-held power tool.

13. The method according to claim 12, wherein:
parameters of the screwing operation are adjustable via the app; and
the parameters comprise at least one of the following parameters:
a diameter and/or type of fastener;
a material, strength, and/or hardness of the substrate; and
a predefined duration and/or number of impacts of a rotary impact operation in
the partially releasing the fastener, the rotating of the tool holder in a second direction, or the renewed rotating of the tool holder in the first direction.

14. The method according to claim 1, wherein:
the method provides screw connection; and
the rotation of the tool holder in the second direction of rotation opposite the first direction of rotation is performed such that jamming of the tool in the tool holder and/or the drive of the fastener with the tool is released, but without the screw connection being tightened such that a renewed loosening of the screw connection in the renewed rotating of the tool holder in the first direction would result in renewed jamming.

15. A computer program for performing a method according to claim 1 when the computer program is executed by a controller of a hand-held power tool.

16. A hand-held rotary impact wrench, comprising:
an electric motor;
a rotary-driven tool holder configured to receive a tool; and
a controller configured to control the electric motor,
wherein the controller is configured to perform the method according to claim 1.
